(19) United States
(12) Patent Application Publication
(10) Pub. No.: US 2025/0178907 A1
(43) Pub. Date: Jun. 5, 2025

(54) METAL-LOADED NANOCARBON SPHERES, AND PREPARATION METHOD AND USE THEREOF

(71) Applicants: THE SECOND HOSPITAL OF DALIAN MEDICAL UNIVERSITY, Dalian City (CN); DALIAN INSTITUTE OF CHEMICAL PHYSICS, CAS, Dalian City (CN)

(72) Inventors: Shuai WANG, Dalian City (CN); Huangzhao WEI, Dalian City (CN); Libo WU, Dalian City (CN); Jie BAI, Dalian City (CN); Jing LI, Dalian City (CN); Xin RONG, Dalian City (CN); Ying ZHAO, Dalian City (CN)

(21) Appl. No.: 18/932,910

(22) Filed: Oct. 31, 2024

(30) Foreign Application Priority Data
Nov. 30, 2023 (CN) 202311623495.9

(51) Int. Cl. C01B 32/18; B01J 20/20

(52) U.S. Cl. CPC C01B 32/18; B01J 20/205; C01P 2002/52; C01P 2004/03; C01P 2004/32

(57) ABSTRACT

Metal-loaded nanocarbon spheres, and a preparation method and use thereof are provided. A nitrogen-containing carbon source, dicyandiamide, and polytetrafluoroethylene are mixed to obtain a mixed powder. The mixed powder is added to formamide and water, and calcium sulfate and/or sodium dodecyl sulfate are then added thereto, and a resulting mixture is subjected to precipitation. Dicyandiamide could stabilize framework, and polytetrafluoroethylene, calcium sulfate and/or sodium dodecyl sulfate act as co-precipitants, causing raw materials to precipitate in the action of repulsive forces to obtain a porous precipitate. The porous precipitate is then impregnated with a metal salt solution and then calcined to obtain metal-loaded nanocarbon spheres.

### CROSS-REFERENCE TO RELATED APPLICATION

This patent application claims the benefit and priority of Chinese Patent Application No. 202311623495.9, entitled “METAL-LOADED NANOCARBON SPHERES, AND PREPARATION METHOD AND USE THEREOF” filed on Nov. 30, 2023, the disclosure of which is incorporated by reference herein in its entirety as part of the present application.

### TECHNICAL FIELD

The present disclosure relates to the technical field of adsorbents, and in particular to metal-loaded nanocarbon spheres, and a preparation method and use thereof.

### BACKGROUND

Hemodialysis is one of the renal replacement therapies for patients with acute and chronic renal failure. During hemodialysis, blood is drained from the body to the outside of the body and passed through a dialyzer consisting of innumerable hollow fibers, where blood in the hollow fibers and an electrolyte solution (dialysate) of a similar concentration as the body outside the hollow fibers exchange substances by means of diffusion, ultrafiltration, adsorption, and convection principles, thus removing the metabolic waste in the body, and maintaining electrolyte and acid-base balance, while removing the excess water in the body, and finally the purified blood is returned to the body. The whole process is called dialysis.

At present, the medical dialysis equipment in hospitals has matured. However, the hemoperfusion cartridges used in dialysis for pets and humans on the market are the same, and there is no hemoperfusion cartridge exclusively designed for pets. Meanwhile, the existing adsorbent materials, such as resins or activated carbon, only offer ordinary adsorption performance, and further improvement is needed. Therefore, how to further improve the adsorption performance of adsorbent materials has become a challenge in existing technology.

### SUMMARY

An object of the present disclosure is to provide metal-loaded nanocarbon spheres, and a preparation method and use thereof. The metal-loaded nanocarbon spheres prepared by the method according to the present disclosure have a higher adsorption effect.

In order to achieve the object described above, the present disclosure provides the following technical solutions.

The present disclosure provides a method for preparing metal-loaded nanocarbon spheres, including the following steps:
(1) mixing a nitrogen-containing carbon source, dicyandiamide, and polytetrafluoroethylene, to obtain a mixed powder;
(2) mixing the mixed powder obtained in step (1) with formamide and water, then adding calcium sulfate and/or sodium dodecyl sulfate thereto, and subjecting a resulting mixture to precipitation, to obtain a porous precipitate;
(3) subjecting the porous precipitate obtained in step (2) to equal volume impregnation with a metal salt solution, to obtain a precursor; and
(4) calcining the precursor obtained in step (3), to obtain the metal-loaded nanocarbon spheres.

In some embodiments, in step (1), a mass ratio of the nitrogen-containing carbon source to the dicyandiamide ranges from 5:1 to 20:1.

In some embodiments, in step (1), a ratio of a mass of the polytetrafluoroethylene to a total mass of the nitrogen-containing carbon source and the dicyandiamide is in a range of 1:100 to 10:100.

In some embodiments, in step (2), a mass ratio of the formamide to the mixed powder ranges from 0.01:1 to 0.05:1.

In some embodiments, in step (2), a ratio of a mass of the mixed powder to a volume of the water is in a range of 6.25 g:100 mL to 6.25 g:300 mL.

In some embodiments, in step (3), metal ions in the metal salt solution include at least one selected from the group consisting of Fe³⁺, Cu²⁺, and Mn²⁺.

In some embodiments, in step (3), a mass ratio of metal ions in the metal salt solution to the porous precipitate ranges from 0.05:100 to 0.5:100.

In some embodiments, the calcining in step (4) is carried out at a temperature of 600-850° C. for 3-8 h.

The present disclosure provides metal-loaded nanocarbon spheres prepared by the method as described in the above technical solutions.

The present disclosure provides use of the metal-loaded nanocarbon spheres as described in the above technical solutions as an adsorbent for hemoperfusion cartridge dialysis for animals.

The present disclosure provides a method for preparing metal-loaded nanocarbon spheres, the method including the following steps: (1) mixing a nitrogen-containing carbon source, dicyandiamide, and polytetrafluoroethylene, to obtain a mixed powder; (2) mixing the mixed powder obtained in step (1) with formamide and water, and then adding calcium sulfate and/or sodium dodecyl sulfate thereto, and subjecting a resulting mixture to precipitation, to obtain a porous precipitate; (3) subjecting the porous precipitate obtained in step (2) to equal volume impregnation with a metal salt solution, to obtain a precursor; and (4) calcining the precursor obtained in step (3), to obtain the metal-loaded nanocarbon spheres. In the present disclosure, a nitrogen-containing carbon source, dicyandiamide, and polytetrafluoroethylene are mixed to obtain a mixed powder, the mixed powder is added to formamide and water, then calcium sulfate and/or sodium dodecyl sulfate are added thereto, and a resulting mixture is subjected to precipitation. Dicyandiamide could stabilize the framework, and polytetrafluoroethylene, and calcium sulfate and/or sodium dodecyl sulfate act as co-precipitants, causing the raw materials to precipitate in the action of repulsive forces to obtain a porous precipitate, which is then impregnated with a metal salt solution and then calcined to obtain metal-loaded microporous nanocarbon spheres. Thus, the adsorption performance of the carbon spheres is improved, and meanwhile, the prepared carbon spheres have smooth surfaces, high strength, no dust, and low bed pressure drop, and are suitable for hemodialysis. The results of the examples show that the carbon spheres prepared according to the present disclosure have a methane adsorption capacity as high as 650 mg/g, a nitrogen adsorption capacity reaching 400 mg/g, and a uric acid adsorption rate reaching 51%.

### BRIEF DESCRIPTION OF THE DRAWINGS

FIG. 1 shows a scanning electron microscope (SEM) image of carbon spheres prepared in Example 1 of the present disclosure at a magnification of 4,000.

FIG. 2 shows an SEM image of carbon spheres prepared in Example 1 of the present disclosure at a magnification of 20,000.

### DETAILED DESCRIPTION OF THE EMBODIMENTS

The present disclosure provides a method for preparing metal-loaded nanocarbon spheres, including the following steps:
(1) mixing a nitrogen-containing carbon source, dicyandiamide, and polytetrafluoroethylene, to obtain a mixed powder;
(2) mixing the mixed powder obtained in step (1) with formamide and water, then adding calcium sulfate and/or sodium dodecyl sulfate thereto, and subjecting a resulting mixture to precipitation, to obtain a porous precipitate;
(3) subjecting the porous precipitate obtained in step (2) to equal volume impregnation with a metal salt solution, to obtain a precursor; and
(4) calcining the precursor obtained in step (3), to obtain the metal-loaded nanocarbon spheres.

Unless otherwise specified, the source of the raw materials is not specifically limited in the present disclosure, and any one commercially available product that is well known to those skilled in the art or product prepared by conventional preparation methods can be used.

In the present disclosure, a nitrogen-containing carbon source, dicyandiamide, and polytetrafluoroethylene are mixed to obtain a mixed powder.

In some embodiments of the present disclosure, the nitrogen-containing carbon source includes p-phenylenediamine or pyrrole.

In some embodiments of the present disclosure, a mass ratio of the nitrogen-containing carbon source to the dicyandiamide ranges from 5:1 to 20:1, and preferably ranges from 5:1 to 10:1. In the present disclosure, the dicyandiamide is used to stabilize the framework.

In some embodiments of the present disclosure, a ratio of a mass of polytetrafluoroethylene to a total mass of the nitrogen-containing carbon source and the dicyandiamide is in a range of (1-10):100, and preferably (5-10):100. In the present disclosure, polytetrafluoroethylene is used to enhance impregnation and subsequent precipitation effects while providing a certain lubrication effect, forming the skeleton portion of the carbon spheres subsequently. By limiting the amount of the nitrogen-containing carbon source, the dicyandiamide, and the polytetrafluoroethylene within the ranges described above, the pore structure and size of the porous precipitate could be adjusted, thereby improving the adsorption effect thereof.

In some embodiments of the present disclosure, the mixed powder has a particle size of 1-900 nm.

In some embodiments of the present disclosure, mixing the nitrogen-containing carbon source, dicyandiamide, and polytetrafluoroethylene includes or consists of: first mixing the nitrogen-containing carbon source and dicyandiamide, and grinding, and then adding polytetrafluoroethylene thereto and continuing to grind. The grinding operation is not specifically limited in the present disclosure, and any one grinding technical solution that is well known to those skilled in the art can be used as long as the particle size of the mixed powder is guaranteed to be within the ranges above. In the present disclosure, the grinding enables a more thorough mixing of the components while preventing excessive agglomeration during precipitation.

In the present disclosure, after obtaining the mixed powder, the resulting mixed powder is mixed with formamide and water, and then calcium sulfate and/or sodium dodecyl sulfate is added thereto, and a resulting mixture is subjected to precipitation, to obtain a porous precipitate.

In some embodiments of the present disclosure, a mass ratio of formamide to the mixed powder is in a range of (0.01-0.05):1, and preferably (0.02-0.04):1. In the present disclosure, the formamide, as part of the solvent, could cause the raw materials to precipitate in the action of repulsive forces.

In some embodiments of the present disclosure, a ratio of a mass of the mixed powder to a volume of water is in a range of 6.25 g:(100-300) mL, and preferably 6.25 g:200 mL. By limiting the amount of the mixed powder, formamide, and water within the ranges described above, the solution system could be adjusted, thereby causing the raw materials to precipitate in the action of repulsive forces.

In some embodiments of the present disclosure, a mass ratio of calcium sulfate to the mixed powder is in a range of (0.1-2):100, and preferably (0.5-1):100.

In some embodiments of the present disclosure, a mass ratio of sodium dodecyl sulfate to the mixed powder is in a range of (1-10):100, and preferably (5-10):100. In the present disclosure, calcium sulfate and/or sodium dodecyl sulfate are co-precipitants, which facilitate the formation of the porous precipitate, and the effect of combined use of the two is better than adding one alone. By limiting the amount of calcium sulfate and/or sodium dodecyl sulfate within the ranges described above, the pore structure and size of the porous precipitate could be adjusted, thereby further improving the adsorption effect of the carbon spheres.

In some embodiments of the present disclosure, the precipitation is carried out for 1-10 h, and preferably 4-6 h. By limiting the precipitation time within the ranges described above, the raw materials could be completely precipitated.

In some embodiments of the present disclosure, after the precipitation, the precipitated products are recovered using a filter membrane, followed by drying to obtain the porous precipitate.

In some embodiments of the present disclosure, the filter membrane has a pore size of 0.22 μm. In some embodiments, the recovery takes 6-48 h. In the present disclosure, it is allowed to replace the filter membrane during the recovery process to ensure the recovery efficiency.

The drying operation is not specifically limited in the present disclosure, and any one drying technical solution that is well known to those skilled in the art can be used.

In the present disclosure, after obtaining the porous precipitate, the resulting porous precipitate is subjected to equal volume impregnation with a metal salt solution to obtain a precursor.

In some embodiments of the present disclosure, the metal salt solution is an aqueous solution of a metal salt. In some embodiments, the metal ions of the metal salt include at least one of Fe³⁺, Cu²⁺, and Mn²⁺. The type of the metal salt is not specifically limited in the present disclosure, and any one metal salt that is well known to those skilled in the art can be used.

In some embodiments of the present disclosure, a mass ratio of the metal ions of the metal salt to the porous precipitate is in a range of (0.05-0.5):100. In the present disclosure, the metal salt forms a metal oxide, which is loaded on the carbon spheres in the subsequent calcining process as an active component, thereby improving the adsorption performance of the carbon spheres. In the present disclosure, the amount of the metal is limited within the ranges described above, such that the metal, in a proper amount, is more uniformly dispersed on the carbon spheres, thereby further improving the adsorption performance of the carbon spheres.

The impregnation time is not specifically limited in the present disclosure, as long as complete impregnation is guaranteed.

In the present disclosure, after obtaining the precursor, the resulting precursor is calcined to obtain the metal-loaded nanocarbon spheres.

In some embodiments of the present disclosure, the calcining is carried out at a temperature of 600-850° C., and preferably 600-800° C. In some embodiments, the calcining is carried out for 3-8 h, and preferably 3.5-6.5 h. In some embodiments, the calcining temperature is reached at a heating rate of 4-6° C./min, and preferably 5° C./min. In some embodiments, the calcining is carried out in a nitrogen atmosphere. During the calcining process in the present disclosure, the nitrogen-containing carbon source, dicyandiamide, and polytetrafluoroethylene form nitrogen-containing carbon spheres, the metal salt forms a metal oxide loaded on the carbon spheres, and meanwhile, sodium dodecyl sulfate and calcium sulfate are removed by calcining. In the present disclosure, the parameters of the calcining are limited within the ranges described above, which enables a more thorough reaction of the raw materials.

In some embodiments of the present disclosure, after the calcining is completed, the calcined product is cooled, washed, and dried sequentially to obtain the metal-loaded nanocarbon spheres.

In some embodiments of the present disclosure, the washing includes or consists of: washing with deionized water and anhydrous ethanol three times in sequence and then detecting the pH value of the wash draining solution. Under the condition that the pH value is between 7 and 8, the standard is reached. If the standard is not reached, washing with anhydrous ethanol is continued until the standard is reached.

In some embodiments of the present disclosure, the drying includes oven drying or freeze-drying.

In some embodiments of the present disclosure, the oven drying is carried out at a temperature of 65-85° C. In some embodiments, the oven drying is carried out for 12-24 h.

In some embodiments of the present disclosure, the freeze drying is carried out at a temperature of −40° C. to −30° C. In some embodiments, the freeze drying is carried out for 12-24 h.

In the present disclosure, a nitrogen-containing carbon source, dicyandiamide, and polytetrafluoroethylene are mixed to obtain a mixed powder, the mixed powder is added to formamide and water, and then calcium sulfate and/or sodium dodecyl sulfate are added thereto, and a resulting mixture is subjected to precipitation. Dicyandiamide could stabilize the framework, and polytetrafluoroethylene, and calcium sulfate and/or sodium dodecyl sulfate act as co-precipitants, causing the raw materials to precipitate in the action of repulsive forces to obtain a porous precipitate, which is then impregnated with a metal salt solution and then calcined to obtain metal-loaded microporous nanocarbon spheres. The type and amount of the raw materials and the reaction parameters are controlled to adjust the pore structure and size of the carbon spheres, such that the adsorption performance of the carbon spheres is improved, and meanwhile, the prepared carbon spheres have smooth surfaces, high strength, no dust, and low bed pressure drop, and are suitable for hemodialysis.

The present disclosure provides metal-loaded nanocarbon spheres prepared by the method as described in the above technical solutions.

The metal-loaded nanocarbon spheres prepared according to the present disclosure include nitrogen-containing microporous nanocarbon spheres and metal oxides loaded on the nitrogen-containing microporous nanocarbon spheres.

The metal-loaded nanocarbon spheres prepared according to the present disclosure have better adsorption performance, smooth surfaces, high strength, no dust, and low bed pressure drop, and are suitable for hemodialysis.

The present disclosure provides use of the metal-loaded nanocarbon spheres as described in the above technical solutions as an adsorbent for hemoperfusion cartridge dialysis for animals.

The operation of using the metal-loaded nanocarbon spheres as an adsorbent for hemoperfusion cartridge dialysis for animals is not specifically limited in the present disclosure, and any one technical solution that is well known to those skilled in the art of using the metal-loaded nanocarbon spheres as an adsorbent for hemoperfusion cartridge dialysis for animals can be used.

The technical solutions of the present disclosure will be described clearly and completely below in conjunction with examples of the present disclosure. Apparently, the described examples are just some examples of the present disclosure, not all of them. Based on the examples in the present disclosure, all the other examples that would have been obtained by persons of ordinary skill in the art without any inventive effort shall fall within the scope of the present disclosure.

### Example 1

(1) 5 g of p-phenylenediamine, 0.75 g of dicyandiamide (the mass ratio of p-phenylenediamine to dicyandiamide being 6.67:1) were ground until the particles were fine without friction feeling. 0.5 g of polytetrafluoroethylene was then added thereto and grinding was continued (the ratio of the mass of polytetrafluoroethylene to the total mass of p-phenylenediamine and dicyandiamide being 8.7:100) to obtain a mixed powder.
(2) The mixed powder obtained after grinding and 0.2 g of formamide (the mass ratio of formamide to the mixed powder being 0.032:1) were added to 200 mL of deionized water (the ratio of the mass of the mixed powder to the volume of water being 6.25 g:200 mL), and 0.05 g of calcium sulfate and 0.5 g of sodium dodecyl sulfate (the mass ratio of calcium sulfate to the mixed powder being 0.8:100, and the mass ratio of sodium dodecyl sulfate to the mixed powder being 8:100) were added simultaneously thereto, and a resulting mixture is subjected to precipitation for 4 h. After the precipitation was completed, the precipitate was filtered out using a 0.22 um filter membrane after filtering for 12 h, during which the filter membrane was replaced once. After the filtration was completed, the precipitate on the two filter membranes was recovered together and dried to obtain a porous precipitate.
(3) The porous precipitate was mixed with an aqueous copper chloride solution for equal volume impregnation, with the mass ratio of copper ions of copper chloride to the porous precipitate being 1.92:100. After the impregnation was completed, the resulting product was dried in an oven at 70° C. for 24 h to obtain a precursor.
(4) The precursor was heated at a heating rate of 5° C./min to a calcining temperature of 640° C. and calcined at 640° C. in a nitrogen atmosphere for 3.5 h. After the calcining was completed, the resulting product was cooled to obtain CuO-loaded metal microporous nanocarbon spheres.

### Example 2

(1) 5 g of p-phenylenediamine, 0.75 g of dicyandiamide (the mass ratio of p-phenylenediamine to dicyandiamide being 6.67:1) were ground until the particles were fine without friction feeling. 0.5 g of polytetrafluoroethylene was then added thereto and grinding was continued (the ratio of the mass of polytetrafluoroethylene to the total mass of p-phenylenediamine and dicyandiamide being 8.7:100) to obtain a mixed powder.
(2) The mixed powder obtained after grinding and 0.2 g of formamide (the mass ratio of formamide to the mixed powder being 0.032:1) were added to 200 mL of deionized water (the ratio of the mass of the mixed powder to the volume of water being 6.25 g:200 mL), and 0.05 g of calcium sulfate and 0.5 g of sodium dodecyl sulfate (the mass ratio of calcium sulfate to the mixed powder being 0.8:100, and the mass ratio of sodium dodecyl sulfate to the mixed powder being 8:100) were added simultaneously thereto, and a resulting mixture is subjected to precipitation for 4 h. After the precipitation was completed, the precipitate was filtered out using a 0.22 um filter membrane after filtering for 12 h, during which the filter membrane was replaced once. After the filtration was completed, the precipitate on the two filter membranes was recovered together and dried to obtain a porous precipitate.
(3) The porous precipitate was mixed with an aqueous ferric chloride solution for equal volume impregnation, with the mass ratio of iron ions of ferric chloride to the porous precipitate being 1.23:100. After the impregnation was completed, the resulting product was dried in an oven at 70° C. for 24 h to obtain a precursor.
(4) The precursor was heated at a heating rate of 5° C./min to a calcining temperature of 700° C. and calcined at 700° C. in a nitrogen atmosphere for 6 h. After the calcining was completed, the resulting product was cooled to obtain Fe₂O₃-loaded metal microporous nanocarbon spheres.

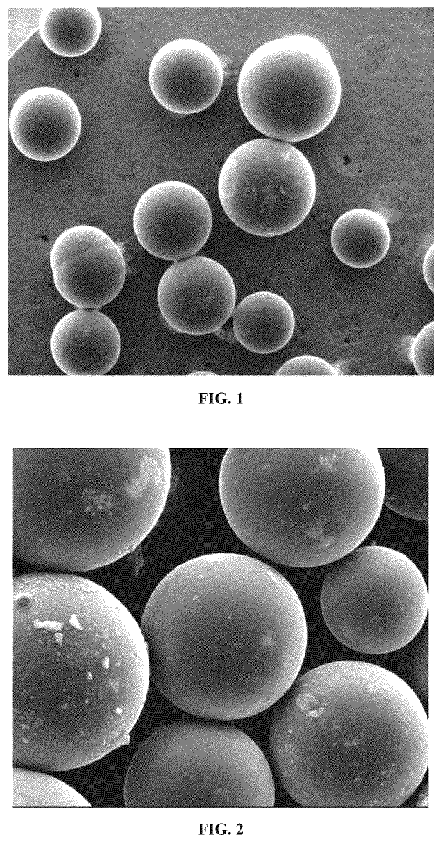

The carbon spheres prepared in Example 1 were observed using a scanning electron microscope. SEM images at different magnifications are shown in FIGS. 1 and 2, in which, the magnification in FIG. 1 is 4,000, and the magnification in FIG. 2 is 20,000. As can be seen from FIGS. 1 and 2, the carbon spheres prepared according to the present disclosure have a smooth surface and are free of dust.

The adsorption capacities of methane and nitrogen by the carbon spheres prepared in Example 1 were tested. The carbon spheres had a methane adsorption capacity as high as 650 mg/g and a nitrogen adsorption capacity as high as 400 mg/g, exhibiting a high adsorption capacity.

The adsorption performance of the carbon spheres prepared in Examples 1-2 and conventional coconut shell charcoal against uric acid was tested. The results are shown in Table 1.

TABLE 1
Adsorption performance of carbon spheres
prepared in Examples 1-2 and
conventional coconut shell charcoal against uric acid

| | Uric acid before | Uric acid after | Adsorption |
|---|---|---|---|
| | adsorption | adsorption | rate |
| Adsorbent | (mg/dL) | (mg/dL) | (%) |
| Example 1 | 10 | 4.9 | 51 |
| Example 2 | 10 | 5.5 | 45 |
| Coconut shell | 10 | 8.9 | 11 |
| charcoal | | | |

As can be seen from Table 1, the carbon spheres prepared according to the present disclosure have better adsorption performance than conventional coconut shell charcoal.

The crushing strength of the carbon spheres prepared in Example 1 was tested using a particle strength tester, obtaining a crushing strength of >20 N.

In summary, the carbon spheres prepared according to the present disclosure have better adsorption performance.

The description above is only the preferred embodiments of the present disclosure. It should be noted that several improvements and modifications may also be made by persons of ordinary skill in the art without departing from the principle of the present disclosure, and that the improvements and modifications should also be considered within the scope of the present disclosure.

What is claimed is:

1. A method for preparing metal-loaded nanocarbon spheres, comprising:
(A) mixing a nitrogen-containing carbon source, dicyandiamide, and polytetrafluoroethylene to obtain a mixed powder;
(B) mixing the mixed powder obtained in step (A) with formamide and water, then adding calcium sulfate and sodium dodecyl sulfate thereto, and subjecting a resulting mixture to precipitation, to obtain a porous precipitate;
(C) subjecting the porous precipitate obtained in step (B) to equal volume impregnation with a metal salt solution, to obtain a precursor; and
(D) calcining the precursor obtained in step (C), to obtain the metal-loaded nanocarbon spheres,
wherein in step (A), a mass ratio of the nitrogen-containing carbon source to the dicyandiamide ranges from 5:1 to 20:1; and
in step (A), a ratio of a mass of the polytetrafluoroethylene to a total mass of the nitrogen-containing carbon source and the dicyandiamide is in a range of 1:100 to 10:100.

2. The method as claimed in claim 1, wherein in step (B), a mass ratio of the formamide to the mixed powder ranges from 0.01:1 to 0.05:1.

3. The method as claimed in claim 1, wherein in step (B), a ratio of a mass of the mixed powder to a volume of the water is in a range of 6.25 g:100 mL to 6.25 g:300 mL.

4. The method as claimed in claim 1, wherein in step (C), metal ions in the metal salt solution comprise at least one selected from the group consisting of Fe³⁺, Cu²⁺, and Mn²⁺.

5. The method as claimed in claim 1, wherein in step (C), a mass ratio of metal ions in the metal salt solution to the porous precipitate ranges from 0.05:100 to 0.5:100.

6. The method as claimed in claim 1, wherein the calcining in step (D) is carried out at a temperature of 600-850° C. for 3-8 h.

7. Metal-loaded nanocarbon spheres prepared by the method as claimed in claim 1.

8. The metal-loaded nanocarbon spheres as claimed in claim 7, wherein in step (B), a mass ratio of the formamide to the mixed powder ranges from 0.01:1 to 0.05:1.

9. The metal-loaded nanocarbon spheres as claimed in claim 7, wherein in step (B), a ratio of a mass of the mixed powder to a volume of the water is in a range of 6.25 g:100 mL to 6.25 g:300 mL.

10. The metal-loaded nanocarbon spheres as claimed in claim 7, wherein in step (C), metal ions in the metal salt solution comprise at least one selected from the group consisting of Fe³⁺, Cu²⁺, and Mn²⁺.

11. The metal-loaded nanocarbon spheres as claimed in claim 7, wherein in step (C), a mass ratio of metal ions in the metal salt solution to the porous precipitate ranges from 0.05:100 to 0.5:100.

12. The metal-loaded nanocarbon spheres as claimed in claim 7, wherein the calcining in step (D) is carried out at a temperature of 600-850° C. for 3-8 h.
